(19) United States
(12) Patent Application Publication
(10) Pub. No.: US 2023/0262350 A1
(43) Pub. Date: Aug. 17, 2023

(54) INFORMATION PROCESSING DEVICE AND INFORMATION PROCESSING METHOD

(71) Applicant: Sony Group Corporation, Tokyo (JP)

(72) Inventor: Justinas MISEIKIS, Stuttgart (DE)

(73) Assignee: Sony Group Corporation, Tokyo (JP)

(21) Appl. No.: 18/107,024

(22) Filed: Feb. 8, 2023

(30) Foreign Application Priority Data
Feb. 15, 2022 (EP) 22156726.6

(51) Int. Cl. H04N 25/47; H04N 23/611; G06V 10/82

(52) U.S. Cl. CPC H04N 25/47; H04N 23/611; G06V 10/82

(57) ABSTRACT

An information processing device, including circuitry configured to:
obtain image data representing an image of a scene;
obtain event image data representing a change in the scene after the image is captured; and
generate updated image data representing an updated image of the scene, based on the image data and the event image data.

### CROSS-REFERENCE TO RELATED APPLICATION

This patent application is based on and claims priority pursuant to European Patent Application No. 22156726.6, filed on Feb. 15, 2022, in the European Patent Office, the entire disclosure of which is hereby incorporated by reference herein.

### TECHNICAL FIELD

The present disclosure generally pertains to an information processing device and an information processing method.

### TECHNICAL BACKGROUND

Generally, virtual reality (“VR”) devices and augmented reality (“AR”) devices (or generally extended reality (“XR”) devices) such as smart glasses are known and typically require a low-latency position tracking, as well as identification and tracking of objects in a scene in the vicinity of the wearer for immersive experience and augmenting reality.

Known color cameras provide an overview of the surrounding environment, however, the latency and the amount of image data and information to be processed may be an issue in a wearable device, such as smart glasses.

Although there exist techniques for image data processing, it is generally desirable to improve the existing techniques.

### SUMMARY

According to a first aspect the disclosure provides an information processing device, comprising circuitry configured to:
obtain image data representing an image of a scene;
obtain event image data representing a change in the scene after the image is captured; and
generate updated image data representing an updated image of the scene, based on the image data and the event image data.

An information processing method, comprising:
obtaining image data representing an image of a scene;
obtaining event image data representing a change in the scene after the image is captured; and
generating updated image data representing an updated image of the scene, based on the image data and the event image data.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates two embodiments of an information processing device;

FIG. 2 schematically illustrates an embodiment of a setup of a camera and an event camera;

FIG. 3 schematically illustrates in a block diagram an embodiment of an information processing device;

FIG. 4 schematically illustrates an embodiment of a training of a neural network;

FIG. 5 schematically illustrates an embodiment of an information processing method;

FIG. 6 schematically illustrates in a flow diagram an embodiment of an information processing method;

FIG. 7 schematically illustrates in a flow diagram an embodiment of an information processing method; and

FIG. 8 schematically illustrates in a flow diagram an embodiment of an information processing method.

### DETAILED DESCRIPTION OF EMBODIMENTS

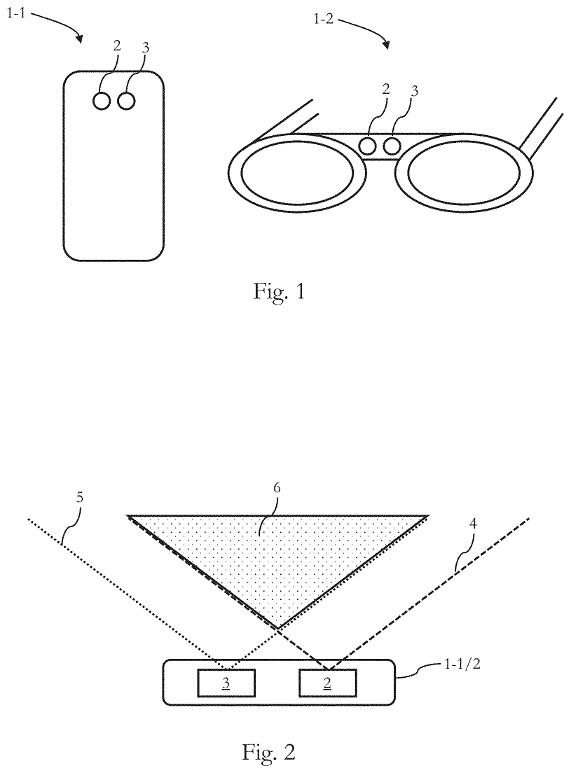

Before a detailed description of the embodiments under reference of FIG. 1 is given, general explanations are made.

As mentioned in the outset, generally, virtual reality (“VR”) devices and augmented reality (“AR”) devices (or generally extended reality (“XR”) devices) such as smart glasses are known and typically require a low-latency position tracking, as well as identification and tracking of objects in a scene in the vicinity of the wearer for immersive experience and augmenting reality.

As further mentioned in the outset, known color cameras provide an overview of the surrounding environment, however, the latency and the amount of image data and information to be processed may be an issue in a wearable device, such as smart glasses.

It has been recognized that a combination of one or more color cameras combined with one or more event cameras (“EVS”) embedded in smart glasses (AR/XR/VR device), facing outside to cover the field-of-view of the user of the device, may provide a low-latency and low-power consumption device for AR/VR/XR applications.

Since, typically, event cameras have low-latency asynchronous data on the changes in the observed area, it has been recognized to utilize them, for example, for low-latency estimation of head movements as well as moving objects, such as hands, controllers or objects in the field-of-view of the color and event cameras. These event cameras are typically low-power consuming, thereby reducing the power consumption of the whole device.

Thus, it has further been recognized that color cameras may provide full visual information of the scene and objects in front of the smart glasses and, by knowing the calibration between the camera and the event camera, a continuous stream of image data from visual cameras may not be needed in some embodiments.

For example, it is envisaged in some embodiments, that color frames are captured for the initial capture of the space and only areas of change (indicated by changes captured by the event camera) are captured subsequently. This way, in some embodiments, the scene is interpolated by utilizing the event camera inputs of changes in the scene, and color image information would be captured only when, for example, new areas of the scene appear, or unseen sides/textures of the object are visible. This may allow to reduce the computational cost of the system, in some embodiments, by relying mainly on event camera inputs and processing full high resolution color images only when needed.

Hence, some embodiments pertain to an information processing device, wherein the information processing device includes circuitry configured to:
obtain image data representing an image of a scene;
obtain event image data representing a change in the scene after the image is captured; and
generate updated image data representing an updated image of the scene, based on the image data and the event image data.

The information processing device may be a mobile device (e.g., a smartphone or tablet), smart glasses, a security camera, a television camera or the like. The information processing device may be a computer or server or the like which obtains the image data and the event image data from a mobile device or smart glasses or the like, generates the updated image data, and transmits the updated image data back to the mobile device or the smart glasses or the like.

The circuitry may be based on or may include or may be implemented by typical electronic components configured to achieve the functionality as described herein.

The circuitry may be based on or may include or may be implemented as integrated circuitry logic and the functionality may be implemented by software executed by a processor or the like. The circuitry may be based on or may include or may be implemented by a CPU (central processing unit), a microcontroller, an FPGA (field programmable gate array), an ASIC (application specific integrated circuit), a GPU (graphical processing unit), a DSP (digital signal processor) or the like.

The circuitry may be based on or may include or may be implemented in parts by typical electronic components and integrated circuitry logic and in parts by software.

The circuitry may include storage capabilities such as magnetic storage, semiconductor storage, etc.

The circuitry may include a data bus for transmitting and receiving data and may implement corresponding communication protocols.

The image data may be gray-scale image data or color image data (e.g., red-green-blue (“RGB”) image data) obtained from a camera and the image data may include pixel values for each image pixel of a plurality of image pixels of an image sensor (grey-scale image sensor, RGB sensor) of the camera. The image data may be represented by an array or matrix including pixel values arranged with dimensions corresponding to the image sensor (e.g., number of rows and columns) or a pixel region of the image sensor (e.g., number of rows and columns) associated with an overlap region of the camera's and event camera's field-of-view (see also FIG. 2).

In some embodiments, the circuitry includes a camera configured to acquire the image data.

Generally, event cameras are known which include an event image sensor including a plurality of event image pixels for generating events. Typically, an event image sensor differs from a conventional image sensor in that each event image pixel asynchronously and independently detects changes in the amount of light incident onto the event image pixel such that the dynamic of a scene is captured rather than a static image of the scene. This may result in a high temporal resolution, low latency, high dynamic range, and low power consumption of event cameras.

As generally known, an event image sensor may generate an event based on an electric signal from an event image pixel (which may also be referred to as event-based vision sensor pixel) in response to a detected change of the amount of light exceeding a threshold. Such an event may identify an event image pixel that generated the event (e.g., column and row index in an event image pixel array), a time when the event was generated, and a polarity indicating whether the change is an increase or decrease of the amount of light.

Typically, the events indicate a change in brightness (or grey-scale value), however, the events may be associated with a color change, for example, when a color filter is used in the event camera.

Thus, the circuitry of the information processing device may receive continuously and asynchronously events (associated with an event image pixel) from an event camera.

The circuitry may obtain the event image data based on the received events, wherein each event is associated with an event image pixel of the event camera that generated the event. The event image data may be represented by an array or matrix including the events (including polarity) arranged with dimensions corresponding to the event image sensor (e.g., number of rows and columns) or a pixel region of the event image sensor (e.g., number of rows and columns) associated with an overlap region of the camera's and event camera's field-of-view (see also FIG. 2). The event image data may correspond to integrated events.

The circuitry may obtain the event image data when a predetermined number of events is received or when a predetermined amount of time has elapsed. However, the circuitry may adapt the predetermined amount of time depending on a number of events received within a predetermined time interval.

In some embodiments, the circuitry includes an event camera configured to acquire events representing the event image data. Different types of event image sensors including, e.g., an event image pixel array is known, for example, Dynamic Vision Sensor (DVS), Asynchronous Time Based Image Sensor (ATIS) or Dynamic and Active Pixel Vision Sensor (DAVIS), which may be used in some embodiments.

The setup of the camera and the event camera is calibrated such that the camera and the event camera have at least a predetermined part of their field-of-views which overlap such that at least a part of the image pixels of the image sensor is associated with an event image pixel of the event image sensor (see also FIG. 2). The number of each type of camera and the layout may be different depending on the form factor, requirements and the use case of the smart glasses or the mobile device.

The circuitry generates updated image data representing an updated image of the scene, based on the image data and the event image data.

In some embodiments, the events are integrated for each event image pixel for estimating a pixel value change (grey-scale or RGB value), and the updated image data is generated by accounting for the estimated pixel value change in the image data (for each image pixel associated with the event image pixel that generated the event(s)).

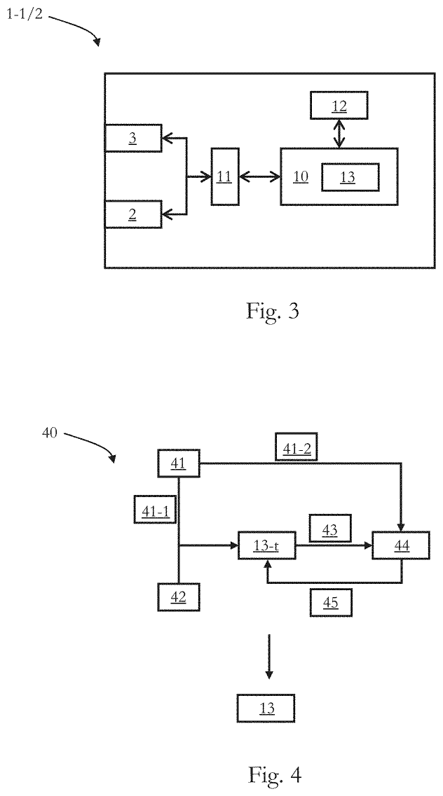

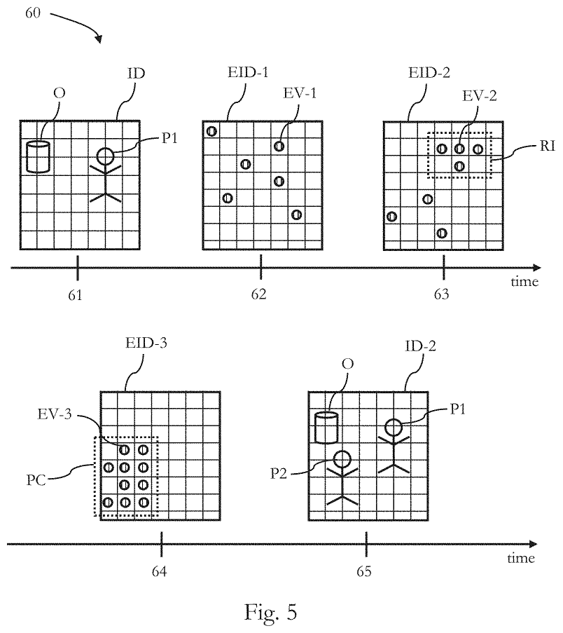

In some embodiments, the circuitry is further configured to input the image data and the event image data into a neural network, wherein the neural network is trained to generate the updated image data based on the image data and the event image data. Such embodiments are discussed under reference of FIG. 3, FIG. 4, and FIG. 5.

In some embodiments, the circuitry is further configured to detect whether a predetermined change has occurred in the scene, based on the event image data.

The predetermined change may be, for instance, the entering of a new object or a person into the scene (e.g., into the overlapping field-of-view of the camera and the event camera), a particular movement of an object or a person in the scene (e.g., in the overlapping field-of-view of the camera and the vent camera) or of parts of the object or the scene, a number of events that have occurred in a predetermined time interval exceeding a predetermined threshold (e.g., within the overlapping field-of-view of the camera and the event camera) or that have occurred in a predetermined region of the scene (e.g., in a predetermined region of the overlapping field-of-view of the camera and the event camera) or that follow a predetermined spatial distribution, a change in illumination conditions (e.g., a cloud moving in front of the sun such that, for example, a larger area of the scene gets darker), or the like, wherein such changes may be typically represented in the event image data.

In some embodiments, the circuitry is configured to input the event image data into a machine learning algorithm (e.g., a decision tree, a support vector machine, a neural network, etc.), wherein the machine learning algorithm is trained to detect whether a predetermined change has occurred.

For example, the machine learning algorithm may be trained with a plurality of event image data (sets) representing a predetermined change such that the machine learning algorithm learns to identify patterns in the event image data which are indicative for the predetermined change.

In some embodiments, the predetermined change is application specific.

For example, the application may be an AR application for a security camera. In such an example, the application may overlay information about persons in the field-of-view and the predetermined change may correspond to the entering of a person in the field-of-view. Accordingly, the machine learning algorithm may be trained to detect such changes.

This may provide, for instance, a filter such that a current image is only acquired when a new person enters the field-of-view, thereby reducing the need to process a large amount of image data frequently.

In some embodiments, the circuitry includes an acceleration sensor, a gyroscope, and the like configured to acquire sensor data for detecting whether the information processing device moves or whether objects or persons in the scene move, which may be used for adapting presentation of AR/VR/AX content to a user.

The sensor data may also be used in the detection of the predetermined change, for example, when the movement of the information processing device exceeds a predetermined threshold or the like.

In some embodiments, the predetermined change is detected further based on the image data.

For example, the circuitry may detect, based on the image data, whether predetermined objects or whether persons are present in the scene such that the circuitry may adapt the predetermined change accordingly (e.g., may select it accordingly from a predetermined list).

In some embodiments, the circuitry is further configured to instruct, after a predetermined amount of time, a camera to acquire second image data representing a second image of the scene.

In such embodiments, the second image data represents a current image of the scene (subsequent to the image represented by the image data and subsequent to the updated image data (updated based on the event image data)). In such embodiments, the second image data is updated based on event image data representing a change in the scene after the current image is captured (thus, the updating process starts again). In such embodiments, the second image data is acquired regularly (e.g., every hundred(s) milliseconds, every second, every two seconds, etc.).

In some embodiments, the circuitry is further configured to instruct, when the predetermined change is detected, a camera to acquire second image data representing a second image of the scene.

In such embodiments, the second image data represents a current image of the scene (subsequent to the image represented by the image data and subsequent to the updated image data (updated based on the event image data)). In such embodiments, the second image data is updated based on event image data representing a change in the scene after the current image is captured (thus, the updating process starts again).

Typically, in AR/VR/XR applications, the virtual objects are synthesized and anchored in the virtual world on top of the actual physical objects seen by the user. By having the main input stream from the event camera and on-demand streaming of color/texture information from the color camera, the system may be optimized in terms of latency and required processing power without sacrificing the user experience.

In some embodiments, the circuitry is further configured to detect a region of interest in the scene, based on at least one of the image data and the event image data.

The region of interest generally corresponds to a part of the scene (e.g., of the overlapping field-of-view of the camera and the event camera) which is assigned a higher importance to be processed (for the application) than the rest of the scene. The regions of interest may be continuously detected and may change over the time.

The importance and thus the region of interest may be based on a number of events generated in a region of the scene (corresponding to an image pixel region on the image sensor of the camera and to an event image pixel region on the event image sensor of the event camera) indicating a larger dynamic of this region of the scene, whether an object or a person is detected (e.g., in front of a background) in a region of the scene, or the like.

In some embodiments, the circuitry is configured to input the image data into a neural network, wherein the neural network is trained to detect whether and where objects or persons are present in the image of the scene.

Typically, events may be generated at edges of objects or persons or generally at transitions from one object to another object or to a background.

The region of interest may thus, for example, be hands of a person, a face of a person, an object, parts of an object, the contour or silhouette of an object or person.

Hence, the region of interest of interest may be detected based on the image data or based on the event image data or based on both.

In some embodiments, the circuitry is further configured to generate the updated image data based on the region of interest represented in the image data.

In such embodiments, the information processing device only processes a subset of the image data corresponding to the region of interest for generating the updated image data. Hence, a processing load may be reduced.

In some embodiments, the circuitry is further configured to generate the updated image data based on the region of interest represented in the event image data.

In such embodiments, the information processing device only processes a subset of the event image data corresponding to the region of interest for generating the updated image data. Hence, a processing load may be reduced.

Some embodiments pertain to a corresponding information processing method, wherein the information processing method includes:
obtaining image data representing an image of a scene;
obtaining event image data representing a change in the scene after the image is captured; and
generating updated image data representing an updated image of the scene, based on the image data and the event image data.

The information processing method may be performed by the information processing device as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there are schematically illustrated two embodiments of an information processing device 1-1 and 1-2, which are discussed in the following.

The information processing device 1-1 is a smartphone and includes a camera 2 and an event camera 3.

The information processing device 1-2 corresponds to smart glasses and includes a camera 2 and an event camera 3.

FIG. 2 schematically illustrates an embodiment of a setup of the camera 2 and the event camera 3.

The camera 2 and the event camera 3 in each of the information processing devices 1-1 and 1-2 are calibrated.

The camera 2 and the event camera 3 have a predetermined distance to each other and calibrated imaging properties.

The camera 2 has a field-of-view 4—indicated by the dashed line—which overlaps with a field-of-view 5—indicated by the dotted line—of the event camera 5 in a region 6—indicated by the dotted area in FIG. 2.

Each of the information processing devices 1-1 and 1-2 processes only the image data and the event image data corresponding to the overlap region 6 (e.g., in the camera 2, the overlap region 6 is associated with a certain image pixel region of the image sensor; in the event camera 3, the overlap region 6 is associated with a certain event image pixel region of the event image sensor).

FIG. 3 schematically illustrates in a block diagram an embodiment of the information processing devices 1-1 and 1-2.

As mentioned above, each of the information processing devices 1-1 and 1-2 includes the camera 2 and the event camera 3.

Moreover, each of the information processing devices 1-1 and 1-2 includes a processor 10 (e.g., an application processor), a data bus 11 (e.g., a data bus in accordance with MIPI (“Mobile Industry Processor Interface”) specifications) for exchanging data with the camera 2 and the event camera 3, and a data storage 12 (e.g., for storing image data and event image data).

The processor 10 executes, among other procedures, a neural network 13.

A user may instruct (e.g., via a user interface) to start an AR application, which is loaded by the processor 10 from the data storage 12.

Then, the processor 10 instructs the camera 2 to acquire image data representing an image of a scene.

The camera 2 transmits the image data over the data bus 11 to the processor 10.

The processor 10 further instructs the event camera 3 to acquire events representing event image data after the image is captured, wherein the event image data represent a change in the scene after the image is captured.

The event camera 3 asynchronously and continuously outputs generated events and transmits the generated events over the data bus 11 to the processor 10.

Then, the processor 10 generates updated image data representing an updated image of the scene, based on the image data and the event image data.

Specifically, the processor 10 inputs the image data and the event image data into the neural network 13, wherein the neural network 13 is trained to generate the updated image data based on the image data and the event image data.

The training of the neural network 13 will be discussed in the following under reference of FIG. 4.

FIG. 4 schematically illustrates an embodiment of a training 40 of the neural network 13.

In the beginning of the training 40, the neural network 13 (e.g., a convolutional neural network) is in a training stage 13-t.

The training 40 is based on ground-truth video data 41, in particular, the ground-truth video data 41 include a plurality of videos. The ground-truth video data 41 are high-speed video data and may correspond to real or simulated data or a combination thereof.

Each video of the plurality of videos includes a plurality of subsequent images (as generally known) of a scene in which changes occur.

The training 40 is further based on ground-truth event video data 42, in particular, the ground-truth event video data 42 include a plurality of subsequent event image data.

Each event image data correspond to changes in the scene occurring in the corresponding video of the ground-truth video data (hence, one video is associated with certain event image data).

The following describes the training for one video which is then repeated for the other videos.

During the training 40, a first image 41-1 of the video (of the ground-truth video data 41) is input into the neural network 13-t in the training stage.

Moreover, during the training 40, the event image data of the corresponding video is input into the neural network 13-t in the training stage.

The neural network 13-t in the training stage outputs updated image data 43, based on the first image and the event image data of the corresponding video.

Specifically, the event image data include a plurality of sub-event image data, wherein each sub-event image data correspond to a different time interval of the video in which changes occur.

Hence, based on the first image 41-1 (represented by first image data) and first sub-event image data (representing changes in the scene in a first time interval of the video), the neural network 13-t in the training stage generates first updated image data (representing an updated image of the scene).

Then, based on the first updated image data and second sub-event image data (representing changes in the scene in a second time interval of the video subsequent to the first time interval of the video), the neural network 13-t in the training stage generates second updated image data.

This is iteratively repeated until each of the plurality of sub-event image data are processed.

Then, the neural network 13-t in the training stage outputs plurality of updated image data 43 to a loss function 44.

The loss function 44 further obtains the rest of the image data of the video 41-2.

Based on a difference between the plurality of updated image data 43 and the rest of the image data of the video 41-2 (each updated image data is compared with the corresponding image data of the video), the loss function 44 generates weight updates 45 for the neural network 13-t in the training stage.

Once the training is completed (all videos are processed), the weights or parameters of the neural network 13 are obtained and, thus, the (trained) neural network 13 is obtained.

FIG. 5 schematically illustrates an embodiment of an information processing method 60.

The information processing method 60 is performed by any of the information processing devices 1-1 and 1-2 of FIG. 3.

At 61, the camera 2 acquires image data (ID) representing an image of a scene in which, for illustration, a static object (O) and a first person (P1) is represented. The camera 2 transmits the image data (ID) over the data bus 11 to the processor 10.

The image data (ID) is illustrated here as an array corresponding to the image pixel region of the image sensor of the camera 2 associated with the overlap region 6 (see FIG. 2) and, thus, the object (O) and the first person (P1) are detected by certain image pixels of the image sensor of the camera 2.

Moreover, the processor 10 inputs the image data into a neural network (not shown; not to be confused with the neural network 13) which is trained to detect whether and where objects or persons are present in the image of the scene.

At 62, the event camera 3 acquires first events (EV-1) during a time interval between 61 and 62. The event camera 3 transmits the first events (EV-1) asynchronously and continuously to the processor 10.

The processor 10 obtains the first events (EV-1) and obtains first event image data (EID-1) therefrom. The first events (EV-1) are distributed over the overlap region 6 (the image pixel region associated with the overlap region 6 and the event image pixel region associated with the overlap region 6 are illustrated here as mapped on each other).

Then, the processor 10 inputs the image data (ID) and the first event image data (EID-1) into the neural network 13, wherein the neural network 13 outputs first updated image data (UID-1; not shown in FIG. 5).

At 63, the processor 10 obtains second events (EV-2) from the event camera 3 which are acquired during a time interval between 62 and 63 and, moreover, the processor 10 obtains second event image data (EID-2) therefrom.

The second events (EV-2) are generated by a small region of the event image pixel sensor and some other event image pixels distributed randomly, as illustrated in FIG. 5.

Then, the processor 10 detects a region of interest (RI) in the scene, based on the image data (ID) and the second event image data (EID-2).

For example, at 61, the processor 10 has detected that the object (O) and the first person (p1) are present in certain image pixel regions. Moreover, the processor 10 detects that a number of events are generated in an event image pixel region that indicates a large dynamic in that region and that corresponds to the image pixel region where the first person (P1) is present.

Hence, for reducing a processing load, the processor 10 only inputs the first updated image data (UID-1) corresponding to the region of interest (RI) and the second event image data (EID-2) corresponding to the region of interest (RI) into the neural network 13, wherein the neural network 13 outputs second updated image data (UID-2) corresponding to the region of interest (RI).

The processor 10 may further replace the image data in the first updated image data (UID-1) corresponding to the region of interest (RI) with the second updated image data (UID-2) corresponding to the region of interest (RI) to obtain third updated image data.

At 64, the processor 10 obtains third events (EV-3) from the event camera 3 which are acquired during a time interval between 63 and 64 and, moreover, the processor 10 obtains third event image data (EID-3) therefrom.

The third events (EV-3) are generated by a border region of the event image pixel sensor and a total number of the third events (EV-3) exceeds a predetermined threshold.

The processor 10 inputs the third event image data (EID-3) into a machine learning algorithm (not shown; not to be confused with the neural network 13), wherein the machine learning is trained to detect whether a predetermined change (PC) in the scene has occurred which is represented in the third event image data (EID-3).

The processor 10 detects that a predetermined change has occurred in the scene and instructs the camera 2 to acquire second image data representing a second image of the scene (a current image of the scene).

Hence, at 65, the camera 2 acquires second image data (ID-2) representing a current image of the scene into which a second person (P2) has entered in addition to the static object (O) and the first person (P1). The camera 2 transmits the image data (ID) over the data bus 11 to the processor 10.

Then, the image update process based on event image data from the event camera 3 starts again.

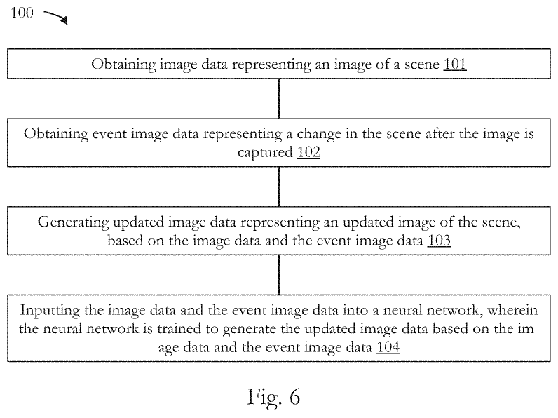

FIG. 6 schematically illustrates in a flow diagram an embodiment of an information processing method 100.

The information processing method 100 may be performed by the information processing device described herein.

At 101, image data is obtained representing an image of a scene, as discussed herein.

At 102, event image data is obtained representing a change in the scene after the image is captured, as discussed herein.

At 103, updated image data is generated representing an updated image of the scene, based on the image data and the event image data, as discussed herein.

At 104, the image data and the event image data are input into a neural network, wherein the neural network is trained to generate the updated image data based on the image data and the event image data, as discussed herein.

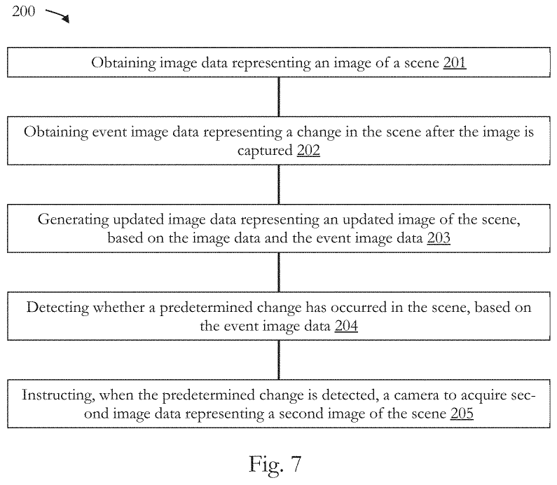

FIG. 7 schematically illustrates in a flow diagram an embodiment of an information processing method 200.

The information processing method 200 may be performed by the information processing device described herein.

At 201, image data is obtained representing an image of a scene, as discussed herein.

At 202, event image data is obtained representing a change in the scene after the image is captured, as discussed herein.

At 203, updated image data is generated representing an updated image of the scene, based on the image data and the event image data, as discussed herein.

At 204, it is detected whether a predetermined change has occurred in the scene, based on the event image data, as discussed herein.

At 205, a camera is instructed, when the predetermined change is detected, to acquire second image data representing a second image of the scene, as discussed herein.

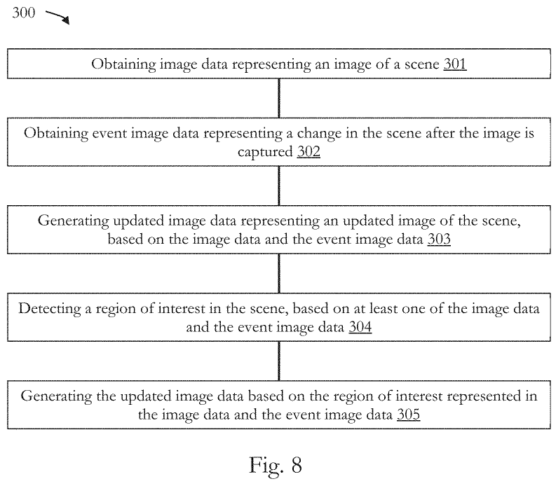

FIG. 8 schematically illustrates in a flow diagram an embodiment of an information processing method 300.

At 301, image data is obtained representing an image of a scene, as discussed herein.

At 302, event image data is obtained representing a change in the scene after the image is captured, as discussed herein.

At 303, updated image data is generated representing an updated image of the scene, based on the image data and the event image data, as discussed herein.

At 304, a region of interest in the scene is detected, based on at least one of the image data and the event image data, as discussed herein.

At 305, the updated image data is generated based on the region of interest represented in the image data and the event image data, as discussed herein.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An information processing device, including circuitry configured to:
obtain image data representing an image of a scene;
obtain event image data representing a change in the scene after the image is captured; and
generate updated image data representing an updated image of the scene, based on the image data and the event image data.

(2) The information processing device of (1), wherein the circuitry is further configured to detect whether a predetermined change has occurred in the scene, based on the event image data.

(3) The information processing device of (2), wherein the predetermined change is detected further based on the image data.

(4) The information processing device of (2) or (3), wherein the circuitry is further configured to instruct, when the predetermined change is detected, a camera to acquire second image data representing a second image of the scene.

(5) The information processing device of anyone of (1) to (4), wherein the circuitry is further configured to detect a region of interest in the scene, based on at least one of the image data and the event image data.

(6) The information processing device of (5), wherein the circuitry is further configured to generate the updated image data based on the region of interest represented in the image data.

(7) The information processing device of (5) or (6), wherein the circuitry is further configured to generate the updated image data based on the region of interest represented in the event image data.

(8) The information processing device of anyone of (1) to (7), wherein the circuitry is further configured to input the image data and the event image data into a neural network, wherein the neural network is trained to generate the updated image data based on the image data and the event image data.

(9) The information processing device of anyone of (1) to (8), wherein the circuitry includes a camera configured to acquire the image data.

(10) The information processing device of anyone of (1) to (9), wherein the circuitry includes an event camera configured to acquire events representing the event image data.

(11) An information processing method, including:
obtaining image data representing an image of a scene;
obtaining event image data representing a change in the scene after the image is captured; and
generating updated image data representing an updated image of the scene, based on the image data and the event image data.

(12) The information processing method of (11), further including:
detecting whether a predetermined change has occurred in the scene, based on the event image data.

(13) The information processing method of (12), wherein the predetermined change is detected further based on the image data.

(14) The information processing method of (12) or (13), further including:
instructing, when the predetermined change is detected, a camera to acquire second image data representing a second image of the scene.

(15) The information processing method of anyone of (11) to (14), further including:
detecting a region of interest in the scene, based on at least one of the image data and the event image data.

(16) The information processing method of (15), further including:
generating the updated image data based on the region of interest represented in the image data.

(17) The information processing method of (15) or (16), further including:
generating the updated image data based on the region of interest represented in the event image data.

(18) The information processing device of anyone of (11) to (17), further including:
inputting the image data and the event image data into a neural network, wherein the neural network is trained to generate the updated image data based on the image data and the event image data.

(19) The information processing method of anyone of (11) to (18), further including:
acquiring, by a camera, the image data.

(20) The information processing method of anyone of (11), further including:
acquiring, by an event image sensor, events representing the event image data.

(21) A computer program comprising program code causing a computer to perform the method according to anyone of (11) to (20), when being carried out on a computer.

(22) A non-transitory computer-readable recording medium that stores therein a computer program product, which, when executed by a processor, causes the method according to anyone of (11) to (20) to be performed.

1. An information processing device, comprising circuitry configured to:
obtain image data representing an image of a scene;
obtain event image data representing a change in the scene after the image is captured; and
generate updated image data representing an updated image of the scene, based on the image data and the event image data.

2. The information processing device according to claim 1, wherein the circuitry is further configured to detect whether a predetermined change has occurred in the scene, based on the event image data.

3. The information processing device according to claim 2, wherein the predetermined change is detected further based on the image data.

4. The information processing device according to claim 2, wherein the circuitry is further configured to instruct, when the predetermined change is detected, a camera to acquire second image data representing a second image of the scene.

5. The information processing device according to claim 1, wherein the circuitry is further configured to detect a region of interest in the scene, based on at least one of the image data and the event image data.

6. The information processing device according to claim 5, wherein the circuitry is further configured to generate the updated image data based on the region of interest represented in the image data.

7. The information processing device according to claim 5, wherein the circuitry is further configured to generate the updated image data based on the region of interest represented in the event image data.

8. The information processing device according to claim 1, wherein the circuitry is further configured to input the image data and the event image data into a neural network, wherein the neural network is trained to generate the updated image data based on the image data and the event image data.

9. The information processing device according to claim 1, wherein the circuitry includes a camera configured to acquire the image data.

10. The information processing device according to claim 1, wherein the circuitry includes an event camera configured to acquire events representing the event image data.

11. An information processing method, comprising:
obtaining image data representing an image of a scene;
obtaining event image data representing a change in the scene after the image is captured; and
generating updated image data representing an updated image of the scene, based on the image data and the event image data.

12. The information processing method according to claim 11, further comprising:
detecting whether a predetermined change has occurred in the scene, based on the event image data.

13. The information processing method according to claim 12, wherein the predetermined change is detected further based on the image data.

14. The information processing method according to claim 12, further comprising:
instructing, when the predetermined change is detected, a camera to acquire second image data representing a second image of the scene.

15. The information processing method according to claim 11, further comprising:
detecting a region of interest in the scene, based on at least one of the image data and the event image data.

16. The information processing method according to claim 15, further comprising:
generating the updated image data based on the region of interest represented in the image data.

17. The information processing method according to claim 15, further comprising:
generating the updated image data based on the region of interest represented in the event image data.

18. The information processing device according to claim 11, further comprising:
inputting the image data and the event image data into a neural network, wherein the neural network is trained to generate the updated image data based on the image data and the event image data.

19. The information processing method according to claim 11, further comprising:
acquiring, by a camera, the image data.

20. The information processing method according to claim 11, further comprising:
acquiring, by an event image sensor, events representing the event image data.
